(19) United States
(12) Patent Application Publication
(10) Pub. No.: US 2015/0274557 A1
(43) Pub. Date: Oct. 1, 2015

(54) METHOD AND APPARATUS FOR PRODUCING SUPER-OXYGENATED WATER

(71) Applicant: BEST ENVIRONMENTAL TECHNOLOGIES,INC., St. Michael (BB)

(72) Inventors: James Gibbs Watson, Edmonton (CA); Mike Bauer, Edmonton (CA); Paul Anthony Thomas, Edmonton (CA)

(21) Appl. No.: 14/442,947

(22) PCT Filed: Nov. 15, 2013
(86) PCT No.: PCT/CA2013/050878

§ 371 Date: May 14, 2015

Related U.S. Application Data
(60) Provisional application No. 61/726,743, filed on Nov. 15, 2012.

(51) Int. Cl. C02F 1/68; C02F 1/72; C01B 5/00; C02F 1/48

(52) U.S. Cl. CPC C02F 1/68; C02F 1/48; C02F 1/727; C01B 5/00; C02F 2103/08

(57) ABSTRACT

Methods and systems for producing super-oxygenated water. The methods and systems combine strategies capable of affording super-oxygenated water and comprise the use of at least two oxygenators arranged in series or in parallel. Super-oxygenated water produced by the methods and systems shows extended stability.

### FIELD OF THE INVENTION

The present invention relates to the field of super-oxygenated water and, in particular, to methods and systems for making super-oxygenated water.

### BACKGROUND OF THE INVENTION

Oxygen is the most plentiful element in Earth's crust and also comprises about 21% of the earth's atmosphere. Its most important compound is water. Oxygen saturation or dissolved oxygen (DO) is a relative measure of the amount of oxygen that is dissolved or carried in a given medium. It can be measured with a dissolved oxygen probe in liquid media. The United States Geological Survey (USGS) extensively defines maximum solubility of elemental oxygen in water in its Field Manual (National Field Manual for the Collection of Water-Quality Data, available online from the USGS website). Depending upon atmospheric pressure, a well-mixed body of water near sea level will be fully saturated with approximately 10 mg/L at 15° C. or about 9 mg/L at 21° C.

It is known that fish and crustaceans are very sensitive when water oxygenation drops below species-specific levels. Typically, the faster the metabolism of the organism, the more oxygen that it requires. Rapid death of these animals from oxygen deprivation has taught aquaculturists to take steps to maintain oxygen levels in their ponds and tanks. Indeed, it has been shown that there is a direct correlation between the level of saturation in the water and the level of produce that may be harvested.

The relationship between supersaturation and animal health is not nearly as well understood. It is known, for example, that below certain levels of oxygenation fish die from aquatic hypoxia and above certain levels morbidity and death also occur. It is also known that these levels are species specific. Accordingly, while the relationship between oxygen saturation requirements and survival are well known, it has been difficult to experimentally determine the optimal super-oxygenation state of water for animal health. In any event, the tolerable upper levels of dissolved oxygen may be highly dependent upon the co-solutes of the particular water and thus carefully controlled study is required.

Similarly, the speed by which wastewater may be processed is very dependent upon the presence of oxygen. Introducing oxygen to the water not only displaces malodorous gases and removes metallic solutes, the oxygen is necessary to sustain the life of the microorganisms which consume the organic matter. By all experience, the more dissolved oxygen in these treatment processes, the better.

In the above fields, there is generally a need for controlled super-oxygenation. In other fields of human endeavor there are specific needs for control of the water being oxygenated. Conversely, oxygenated waters for the research, medical, or food industries must be reproducible and subject to quality definition and scientific measurement. Those familiar with nano level technologies will understand that in this size range compositions sometimes behave in unexpected ways that are not clearly predictable by classical or quantum physics, and that these behaviours need to be verified experimentally. Without reproducibility, it is difficult to define the product and create intended-use statements. For example, oxygenated water is reportedly beneficial for carrier fluids, ultrasonic imaging, wound care, eye care, washing systems, cryoprotection, and other specific applications. While high oxygen is deemed desirable, in most instances there are metal ions present that assist in the achievement of stable and specified levels of oxygen in the produced water. Bottled water with claims of super-oxygenation has been sold under brand names such as Aqua Rush, Athletic Super Water, SerVenRich and AquOforce.

There have been many strategies employed to oxygenate water. For example, fine bubble aerators, coarse bubble aeration, paddle wheels, spray aerators, waterfall aerators, turbine aerators, down flow bubble contractors (DFBC, also referred to as bicones or Spreece cones), counter-current diffusion columns, U-tube dissolvers, Low Head Oxygenators (LHOs), Medium Head Oxygenators, pressurized spray towers, pressurized packed columns, Venturi injection devices, ultrasound devices, electrostatic discharge devices, and magnetically augmented oxygenators. These devices are all capable of oxygenating or even super-oxygenating aqueous solutions for short periods of time.

The traditional assumption has been that all oxygenated waters have similar physico-chemical structure and function, however, this understanding has been challenged recently. There is now considerable evidence that sub-micron-sized oxygen-filled “nanobubbles” can exist for significant periods of time in aqueous solution. These nanobubbles allow the solution to hold levels of oxygen beyond the USGS-defined levels for useful periods of time. It is thought that this stability effect may be increased by the presence of additional charged materials that favour the gas-liquid interface, such as metal ions and halide ions (see U.S. Patent Application Publication No. 2007/0286795). This line of logic holds that the presence of long-lived nanobubbles is due to the fact that the gas/liquid interface is charged, introducing an opposing force to the surface tension, so slowing any release of molecular oxygen species. The corollary to this theory is that nanobubbles would not be able to persist in solute-free water in the absence of exogenous pressure.

Oxygen supersaturation has been described in the following documents:

U.S. Pat. No. 8,142,550 reports a stable super-oxygenated water that has an initial total dissolved solids (TDS) in the 5-20 ppm range and a final TDS in the produced water of between 30-50 ppm. The oxygenated fluid is made by establishing a pressurized flow of a fluid; injecting a flow of oxygen into the fluid; introducing colloid materials into the fluid/oxygen mixture; passing the mixture through a Venturi assembly while subjecting the mixture to a magnetic field from an adjacent magnetic assembly; and then flowing the mixture from the Venturi assembly to a gas/liquid separation tank. The reported data with respect to oxygenated water is from a system that uses an inline chiller to cool spring water to 10° C. to improve capacity and retention time for the oxygen.

U.S. Patent Application Publication No. 2010/0301498 describes a gas/liquid mixing device for an ozonated water generator for generating highly soluble and highly concentrated ozonated water. The device comprises a magnetically transparent Venturi tube having a small diameter section midway in a large diameter section; a gas supply pipe to supply gas to a liquid that is passing through the small diameter section and a magnet outside of the Venturi tube to generate magnetic force lines capable of extending through at least the small diameter section and the vicinities of the small diameter section. Ozonated water generated using the described device contained ozone bubbles having a gas bubble size of less than 50 nm and was capable of retaining the dissolved ozone for about 32 hours.

U.S. Patent Application Publication No. 2002/0096792 describes an apparatus for dissolving a gas into a liquid comprising a Venturi means; a diffuser means associated with the Venturi means for diffusing gas into the liquid; means for controlling the liquid through the Venturi means in a laminar zone as gas is introduced into the liquid. The holes in the diffuser are described as being sized so as to minimize the size of the bubbles being introduced into the water. Oxygen levels of 48-50 mg/l in the treated water are described.

U.S. Patent Application Publication No. 2007/0286795 describes oxygen nanobubble water, which is an aqueous solution comprising oxygen-containing nanobubbles having a bubble diameter of 200 nm or less. The oxygen nanobubble water is described as having pH=8.4, hardness=1000 mg/L, iron<0.03 mg/L, manganese=0.016 mg/L, sodium=2200 mg/L and chloride ion=2110 mg/L. Electrolytes are indicated as being necessary to maintain stable nanobubbles.

U.S. Patent Application Publication No. 2010/0151041 describes a hyper-saturated aqueous solution (HSAS) comprising dissolved molecular oxygen in the range of 75 to 2000 mg/l. HSAS are reportedly metastable at ambient pressure under certain conditions if the energetic requirements for homogeneous nucleation of gas bubbles are not satisfied. Thus, aqueous solutions with an oxygen tension equivalent to saturation at 60-80 atmospheres and greater are purportedly produced and maintained at ambient pressure for a reasonable time interval.

U.S. Patent Application Publication No. 2004/0016706 describes a water purification system that repeatedly circulates ozone through an ozone injector to maintain the level of ozone in the water. The system includes a pump which receives the water and pumps it into an expansion tank. From the expansion tank the water flows through an ozone generation and impregnation device wherein the water receives the ozone. After impregnation, water flows into a holding tank. The pump is also in communication with an external demand source and if ozone impregnated water is needed, water flows back to the pump and is diverted to the source. If there is no demand sensed, water flows back to the pump and is cycled through the ozone impregnation device again.

International Patent Application Publication No. WO2008/047958 describes an apparatus capable of producing super-oxygenated water. The oxygenating apparatus circulates water contained in a water reservoir and dissolves oxygen from an oxygen source into the circulated water flow. A pump coupled to the water reservoir circulates the water, which is passed through an oxygen dissolving device that dissolves oxygen from the oxygen source to water supplied by the pump. A plurality of trays are installed in cascade vertically in a housing of the oxygen dissolving device and function to split the oxygen bubbles in the water, which purportedly increases the level of the dissolved oxygen in the water. The water exiting the oxygen dissolving device may be recirculated through the apparatus in order to increase the level of dissolved oxygen.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

The present invention relates generally to methods and apparatus for producing super-oxygenated water. In one aspect, the invention relates to a method for producing super-oxygenated water having a minimum dissolved oxygen (DO) content, the process comprising: (a) passing a source water through a plurality of oxygenators under conditions allowing introduction of oxygen into the source water to provide oxygenated water, the plurality of oxygenators comprising at least two different oxygenators arranged in series or in parallel; (b) passing the oxygenated water through one or more of the plurality of oxygenators one or more times as necessary to provide super-oxygenated water having the minimum DO content, and (c) collecting the super-oxygenated water, wherein the minimum DO content is at least 20 mg/L and the super-oxygenated water has a super-oxygenation half-life of 12 hours or more in an open tank at ambient temperature and pressure.

In another aspect, the invention relates to a method for producing super-oxygenated water essentially free of ions, particulates and solutes and having a minimum dissolved oxygen (DO) content, the process comprising: a) passing a source water that has been treated to remove ions and solutes through a plurality of oxygenators under conditions allowing introduction of oxygen into the source water to provide oxygenated water, the plurality of oxygenators comprising at least two different oxygenators arranged in series or in parallel; (b) passing the oxygenated water through one or more of the plurality of oxygenators one or more times as necessary to provide super-oxygenated water having the minimum DO content, and (c) collecting the super-oxygenated water, wherein the minimum DO content is at least 20 mg/L and the super-oxygenated water has a super-oxygenation half-life of 12 hours or more in an open tank at ambient temperature and pressure.

In another aspect, the invention relates to a super-oxygenated water having a minimum dissolved oxygen (DO) content of 20 mg/L produced by the method according to any one of claims 1 to 35, wherein the super-oxygenated water has a super-oxygenation half-life of 12 hours or more in an open tank at ambient temperature and pressure.

In another aspect, the invention relates to a system configured to carry out the method according to any one of claims 1 to 35, the system comprising a plurality of oxygenators, the plurality of oxygenators comprising: a first oxygenator adapted to receive a source water; a second oxygenator arranged in parallel with the first oxygenator and adapted to receive the source water, or a second oxygenator arranged in series with the first oxygenator and adapted to receive in-process water from the first oxygenator; an oxygen source in communication with at least one of the first and second oxygenators and adapted to provide oxygenating gas thereto, and a pump configured to pump water through the system.

### BRIEF DESCRIPTION OF THE DRAWINGS

These and other features of the invention will become more apparent in the following detailed description in which reference is made to the appended drawings.

FIG. 1 is a flowchart providing a general overview of the steps in a method of producing super-oxygenated water in one embodiment of the invention; dotted lines delineate optional steps.

FIG. 2 is a flowchart depicting a method of producing super-oxygenated water in one embodiment of the invention that employs a plurality of oxygenation steps conducted in series; dotted lines delineate optional steps.

FIG. 3 is a flowchart depicting a method of producing super-oxygenated water in one embodiment of the invention that employs a plurality of oxygenation steps conducted in parallel; dotted lines delineate optional steps.

FIG. 4 is a flowchart depicting a method of producing super-oxygenated water in one embodiment of the invention that employs a plurality of oxygenation steps conducted both in parallel and in series; dotted lines delineate optional steps.

FIG. 5 presents flow charts depicting configurations for the system in certain embodiments of the invention in which the oxygenators are arranged in series.

FIG. 6 presents flow charts depicting configurations for the system in certain embodiments of the invention in which two oxygenators are arranged in parallel.

FIG. 7 depicts a system for producing super-oxygenated water in accordance with one embodiment of the invention.

FIG. 8 depicts a system for producing super-oxygenated water in accordance with another embodiment of the invention.

FIG. 9 depicts a system for producing super-oxygenated water in accordance with a further embodiment of the invention.

### DETAILED DESCRIPTION OF THE INVENTION

The invention relates generally to methods and apparatus for producing super-oxygenated water. The methods and apparatus described herein combine strategies capable of affording super-oxygenated water and super-oxygenated aqueous solutions. While super-oxygenation may be achieved by using apparatus such as ultrasound, low head oxygenators (LHOs), Venturi apparatus, diffusers, and other apparatus individually, it has been found that combining the use of a plurality of these apparatus affords solutions or suspensions with one or more of superior levels of oxygenation, stability, and/or reproducibility.

While not being bound by any particular theory, it is thought that the character of the oxygenated water from any given treatment (for example, bubble size dispersion) is different and that treatment by multiple methods may bring nanobubble bubble size to near homogeneity. This homogeneity may afford equalization of the internal bubble pressures and repulsive forces of the individual bubbles. Such uniformity may promote stability of the solution.

It is also thought that each type and each model of oxygenation apparatus (“oxygenator”) will have unique bubble-size distribution signatures. Accordingly, what was heretofore thought of as super-oxygenated water may actually be polydisperse suspensions of oxygen which temporarily register as supersaturated on dissolved oxygen meters. However, over fairly short periods of time, when exposed to open atmosphere the gas easily escapes. Without being bound by theory, it is thought that by treating the oxygenated water produced by one apparatus with an apparatus with a distinct bubble-size distribution signature, a tighter distribution of bubble size can be achieved. It is also thought that tightly dispersed or monodisperse bubble suspensions of oxygen will exhibit superior longevity of supersaturation. For example, treating pure water until it reaches supersaturation with mean nanobubble diameters less than, for example, 200 nM, may result in a product with superior stability. Addition of electrolytes after achieving a given level of homogeneity of solution may further stabilize the oxygenation of aqueous solutions.

Accordingly, certain embodiments of the invention relate to methods for producing super-oxygenated water having a minimum dissolved oxygen (DO) content that comprise passing water or aqueous fluids through a plurality of oxygenators, the plurality of oxygenators comprising at least two different oxygenators arranged in series or in parallel. Certain embodiments relate to systems for producing super-oxygenated water having a minimum dissolved oxygen (DO) content that comprise a plurality of oxygenators, the plurality of oxygenators comprising at least two different oxygenators arranged in series or in parallel.

Depending upon atmospheric pressure, a well-mixed body of water will be fully oxygen saturated with approximately 10 mg/L at 15° C. or about 9 mg/L at 21° C. Supersaturated or super-oxygenated water/aqueous solutions as discussed herein are considered to be those that have a dissolved oxygen (DO) content above calculated solubility. In some embodiments, the super-oxygenated water produced by the methods and systems described herein has a minimum DO content of at least 2 times saturation.

In certain embodiments, the methods and systems described herein are capable of producing super-oxygenated water at a given temperature and pressure having a minimum DO content exceeding 2 time saturation. In certain embodiments, the methods and systems described herein are capable of producing super-oxygenated water having a minimum DO content of 20 mg/L or greater. In some embodiments, the methods and systems described herein are capable of producing super-oxygenated water having a minimum DO content of 30 mg/L, 40 mg/L, or 50 mg/L.

In certain embodiments, the methods and systems described herein are capable of producing super-oxygenated water having a DO content that exceeds 20 mg/L at 1 bar. In some embodiments, the methods and systems described herein are capable of producing super-oxygenated water having a DO content of 30 mg/L or greater; 40 mg/L or greater, or 50 mg/L or greater at 1 bar.

In certain embodiments, the methods and systems described herein are capable of producing super-oxygenated water having a minimum DO content of 20 mg/L or greater at 1 bar when the temperature is in the range of 15° C. to 23° C. In some embodiments, the methods and systems described herein are capable of producing super-oxygenated water having a minimum DO content of 30 mg/L, 40 mg/L, or 50 mg/L at 1 bar when the temperature is in the range of 15° C. to 23° C.

In certain embodiments, the methods and systems described herein produce super-oxygenated water with improved stability. For example, in some embodiments, the super-oxygenated water produced by the methods and systems described herein has a super-oxygenation half-life of 12 hours or more in an open tank at ambient temperature and pressure. In certain embodiments, the super-saturated water produced by the methods and systems described herein demonstrates an extended stability when bottled. For example, in some embodiments, the DO content of the super-oxygenated water produced by the methods and systems described herein remains above saturation at ambient temperature and pressure for 4 months or more when stored in bottles. In certain embodiments, the described methods and systems are capable of producing super-oxygenated water having improved stability without the need to introduce colloids into the water during processing.

### DEFINITIONS

Unless defined otherwise, all technical and scientific terms used herein have the same meaning as commonly understood by one of ordinary skill in the art to which this invention belongs.

As used herein, the term “about” refers to an approximately +/−15% variation from a given value. It is to be understood that such a variation is always included in any given value provided herein, whether or not it is specifically referred to. In certain embodiments, the term “about” may refer to an approximately +/−10% variation from a given value.

The term “plurality” as used herein means more than one, for example, two or more, three or more, four or more, and the like.

The use of the word “a” or “an” when used herein in conjunction with the term “comprising” may mean “one,” but it is also consistent with the meaning of “one or more,” “at least one” and “one or more than one.”

As used herein, the terms “comprising,” “having,” “including” and “containing,” and grammatical variations thereof, are inclusive or open-ended and do not exclude additional, unrecited elements and/or method steps. The term “consisting essentially of” when used herein in connection with a system, use or method, denotes that additional elements and/or method steps may be present, but that these additions do not materially affect the manner in which the recited system, method or use functions. The term “consisting of” when used herein in connection with a system, use or method, excludes the presence of additional elements and/or method steps. A system, use or method described herein as comprising certain elements and/or steps may also, in certain embodiments consist essentially of those elements and/or steps, and in other embodiments consist of those elements and/or steps, whether or not these embodiments are specifically referred to.

### SYSTEMS

In one aspect, the invention relates to systems for producing super-oxygenated water from a source water. The systems comprise a plurality of oxygenators, at least two of which are different types of oxygenators arranged either in series or in parallel. In certain embodiments, the system may comprise at least two different oxygenators in series. In certain embodiments, the system may comprise at least two different oxygenators in parallel. The term “oxygenator” is used herein to refer to an apparatus or device capable of oxygenating a fluid by introducing oxygen into the fluid from an exogenous source, or by mixing with in-process oxygenated water, or by mixing or otherwise treating the water such that the dissolved oxygen content is increased.

The system may be either a flow-through or a recirculating system. In flow-through systems, in-process water may be treated multiple times with identical, similar or different oxygenators. In recirculating systems, in-process water may be returned to the same apparatus for repeat treatment. The number of treatments by each apparatus need not be equal and an empirical determination may be undertaken with any given elaboration of oxygenation devices to verify oxygenation according to water quality and intended-use specifications.

The term “source water” is used herein broadly and may include aqueous fluids from almost any source and will typically be selected depending on the intended use of the produced super-oxygenated water. Accordingly, in various embodiments, the source water may be municipal water, sea water, fresh water, aquaculture water, irrigation water, industrial water, wastewater, tap water, well water, distilled water, purified water, or the like. In certain embodiments, the source water is purified water. In some embodiments, the source water is essentially free of ions, particulates and solutes. By “essentially free of ions, particulates and solutes” it is meant that the amount of ions, particulates and solutes are below levels detectable by conventional detection methods. The system may include one or more tanks so that the source water may be stored prior to treatment and/or in-process water may be stored between treatments.

Typically, the system comprises a source water input system, which may include one or more pumps. In certain embodiments, one or more source water input pump is configured to increase the pressure of the source water. Additional pumps may be included in the system in some embodiments and may be used, for example, to increase the pressure of the in-process water as it passes through the oxygenators of the system. Suitable pumps are well-known in the art and are available from any of a large variety of manufacturer. The one or more pumps can readily be selected by one skilled in the art to circulate the volume and type of fluid to meet the scale of the system design and the pressure specifications of the individual apparatus used in the system.

Those familiar with the art will recognize that it may be desirable to include one or more piped circuits for in-process water such that the system may incorporate automated or logic functions. In these embodiments, one or more apparatus such as manifolds, valves, sensors, flow meters, level meters, pressure meters, dissolved oxygen meters and the like may be included in the system to monitor and regulate the production of in-process and product waters. In certain embodiments, data from the in-process water circuits may be acquired and logged. In some embodiments, data from the in-process water circuits may be acquired and logged, and the acquired data may be used for automated switching of control circuits. Such control circuits may be accessed manually by an operator or automatically by a computer software program.

In certain embodiments, the system may further comprise one or more water purifying apparatus to remove unwanted components from the source water prior to oxygenation. For example, one or more water purifying apparatus that remove particulates, solvents, minerals, microbes, dissolved solids and/or metal ions may be included. Examples of such water purifying apparatus include, but are not limited to, various filters, reverse osmosis equipment, deionization apparatus, apparatus for application of UV light, irradiation equipment and distillation equipment, which are known in the art and are commercially available through numerous suppliers (for example, Whatman, Millipore). The selection of water purification equipment may depend on the source water selected for oxygenation and the residues desired in the product water. The equipment may, for example, be selected to be capable of providing unoxygenated water at a predefined level of purity. Appropriate apparatus can be readily selected by those skilled in the art. In an alternative embodiment, water from commercial suppliers may be used to meet the target specification.

The system further comprises one or more oxygen sources in communication with one or more of the oxygenators for introducing oxygen into the water being treated. The oxygen source may be, for example, air, oxygen, ozone, hydrogen peroxide, or a combination thereof. Typically, the oxygen source is capable of supplying oxygen-containing gas. Means for supplying oxygen-containing gas are well known in the art and include, without limitation, air, oxygen gas, liquid oxygen, and oxygen generators. Oxygen can also be generated using either a pressure swing adsorption (PSA) or a vacuum swing adsorption (VSA) unit, or an electrolytic oxygen generator. Commercially available units can produce anywhere from 1 to 30 lbs (0.5 to 14 kg) of oxygen per hour at from 10 to 50 psi (0.7 to 3.3 atmospheres). PSA and VSA units may operate on an on-demand basis. While systems may be selected for economy and the ability to meet demand for oxygen saturation, in certain embodiments, for example for producing pure, super-oxygenated water, the oxygen source selected may be one that can deliver sufficient oxygen at 85% purity or better.

The system comprises a plurality of oxygenators. In certain embodiments, the system is configured to employ serial processing to obtain controlled oxygenation of a final aqueous product. In some embodiments, the system is configured to process source or in-process water by one or more different methods in parallel and to mix the processed water to obtain a particular oxygenation profile that may not be attainable through a serial process. Accordingly, a mixture of in-process waters may be used to obtain the super-oxygenated water in certain embodiments. In certain embodiments, the system is configured to allow a combination of serial and in-parallel processing steps.

Various oxygenators are known in the art. Examples include, but are not limited to, oxygen injection devices such as Venturi apparatus; diffusers, misters and various gas-transfer units including, for example, U-tubes, packed columns, spray towers, low head oxygenators, medium head oxygenators and aeration cones.

In certain embodiments, at least one of the oxygenators included in the system is a Venturi apparatus. The Venturi apparatus may be used individually or in serial or parallel fashion. In certain embodiments, the Venturi apparatus serves as a point for introduction of oxygen into the system and may be used as a sole, primary or secondary injector of oxygen into source and/or in-process water. Venturi apparatus are widely available commercially, may be made from a variety of materials, and have various connection means and dimensional specifications. For example, Mazzei Injector Company, LLC (Bakersville, Calif.) sells a variety of Venturi-injector models with a broad range of specifications. Venturi apparatus may be used with or without the influence of magnets. In certain embodiments, the system comprises one or more Venturi apparatus that is used without the influence of magnets. Suitable Venturi apparatus for inclusion in the system can readily be selected by the skilled person taking account of the size of the oxygenation system envisioned and the intended use of the product.

In some embodiments, at least one of the oxygenators included in the system is a diffuser, which may be used for one or more diffusion steps. In certain embodiments, the system may comprise a plurality of progressively finer diffusers. Diffusers are commercially available from a variety of suppliers, such as O2Canada Water Inc. or Seimens Water Technologies (Alpharetta, Ga.). Diffusers may be of the metal, membrane, or ceramic type depending upon the aqueous solution targeted and may have various configurations such as plate, disc, dual disc, tube or ring configurations. Both fine bubble and coarse bubble diffusers are contemplated. In certain embodiments, a fine bubble diffuser is employed. The skilled worker can readily select an appropriate material and style of diffuser for inclusion in the system taking into account target volumes, as well as source and output waters. Manufacturers typically provide performance characteristics and limitations of each diffuser for each intended use with their product literature. Accordingly, the skilled worker can also select either a low, medium and high mesh size as appropriate for the diffuser. If necessary various mesh sizes may be tested by routine means and outcomes measured against target performance characteristics. In certain embodiments in which purified water, such as reverse-osmosis water is used as a source water, stainless steel diffusion meshes measuring 100 microns or less, 50 microns or less, or 25 microns may be employed. In certain embodiments, a stainless steel diffuser of 100 microns mesh size or smaller is employed.

In some embodiments, a combination of a Venturi apparatus and a diffuser are utilized such that oxygen is diffused into the Venturi through the diffuser. In some embodiments, the oxygen is diffused at the Venturi apparatus by one or more diffusers with a selected mesh size. The post-Venturi, in-process fluid embodying oxygen bubbles may be reprocessed with one or more diffusers having a selected mesh size.

In certain embodiments, the system includes at least one gas-transfer unit that controllably exchanges gas at the gas:liquid interphase. In some embodiments, units that control the gas phase by injecting oxygen under a collection hood may be used. In some embodiments, sealed units that allow the control of the gas phase through introduction of oxygen into a head-space may be used. In certain embodiments, the system comprises an oxygenator having at least one chamber containing source or in-process water. In some embodiments, a gas-transfer unit that contains baffles may be used. Oxygenation chambers may be custom made or purchased from a variety of manufacturers. In certain embodiments, the system comprises one or more diffusion chambers.

In certain embodiments, the system includes at least one low-head oxygenator (LHO), such as the LHO described in U.S. Pat. No. 4,880,445. LHOs are available from a number of commercial vendors.

The system may further comprise one or more static mixers. The static mixers may be incorporated into the system between oxygenators, after the final oxygenator in the system, or both. In certain embodiments, the system includes a static mixer positioned to mix oxygenated water after it has passed through all of the oxygenators in the system. Other solutions, such as flavours, colours, or other desired additives, may optionally be introduced to a final product at the static mixer.

The type of oxygenators employed and the order they are included within the system may be flexible. In some embodiments, the system comprises a Venturi apparatus, one or more diffusers and one or more LHOs. In some embodiments, the system comprises a Venturi apparatus, one or more diffusers and one or more LHOs and the system is configured to pass water from the Venturi apparatus through the one or more diffusers and then through the one of more LHOs. In certain embodiments in which a plurality of LHOs are employed, a diffuser may be included between LHOs.

The in-process water may be treated multiple times to achieve specific oxygenation targets and the system may, therefore, be configured for recirculation of the oxygenated water through one or more of the oxygenators. Depending upon the desired fluid product, the final step may include one or more static mixers.

In certain embodiments, the system comprises a combination of one or more sources of oxygen-containing gas, one or more fluid pumps, one or more diffusers, one or more Venturi apparatus, one or more interphase oxygenators and one or more static mixers to achieve high levels of stably oxygenated aqueous solutions. In certain embodiments, the system is configured to circulate the target fluid through a Venturi apparatus wherein oxygen-containing gas is injected into a fluid stream pumped from a body of fluid prior to fluid egress from the venture apparatus. The system may be configured to pass the resulting in-process mixture through another diffuser to reduce bubble size, and to pump the in-process fluid therefrom through a low-head oxygenator. Optionally the in-process water is passed through a static mixer.

The system may be configured for operation at ambient temperature, or it may be configured to operate at other selected temperatures. In some embodiments, the system may comprise one or more chillers for reducing the temperature of the source and/or in-process water. In certain embodiments, the system is configured to operate at ambient temperature and does not require that the source or in-process water is chilled.

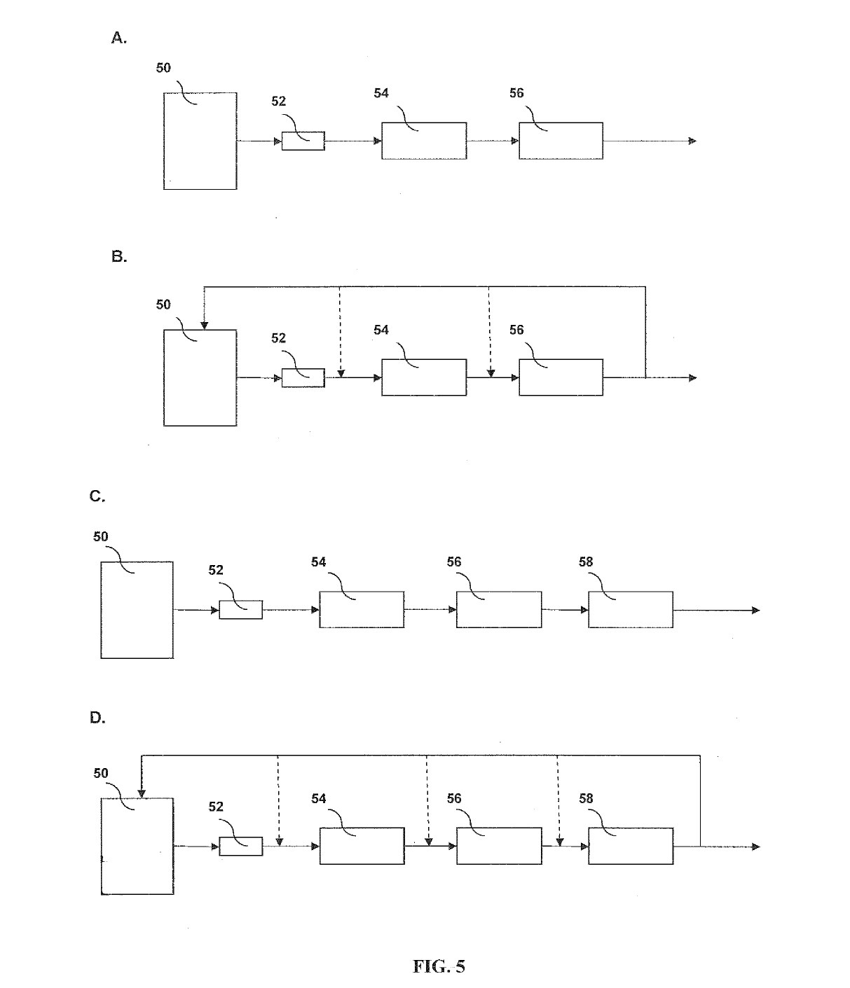

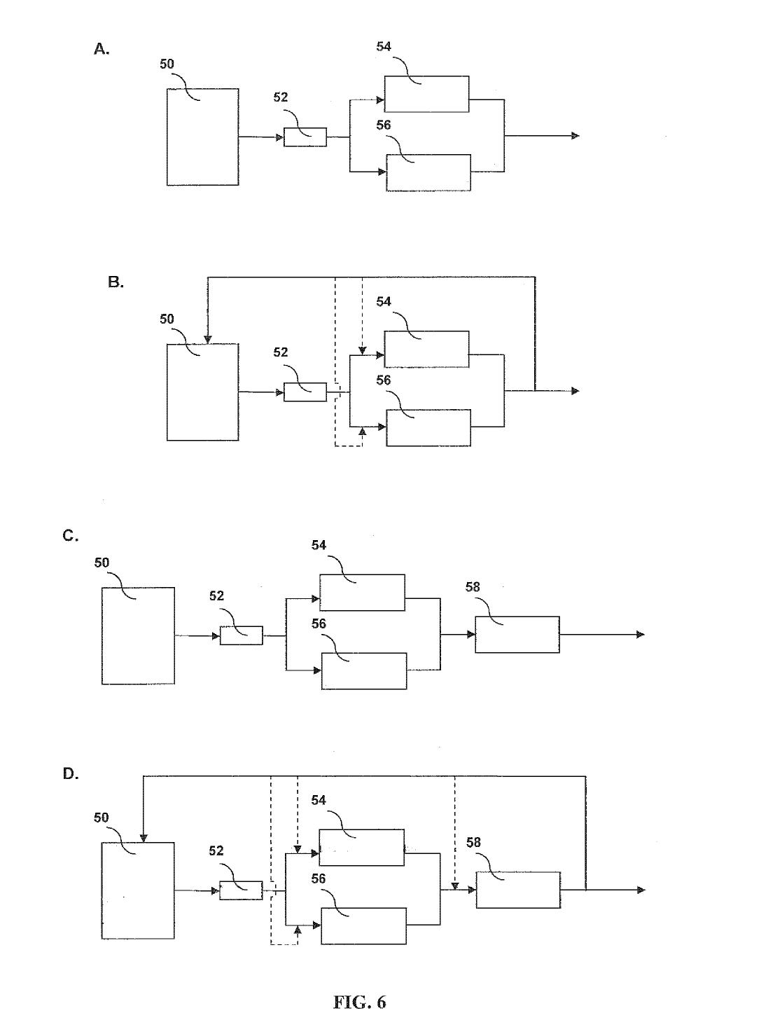

Non-limiting examples of possible configurations of the system to provide super-oxygenated water in various embodiments of the invention are provided in FIGS. 5 and 6. Although FIGS. 5 and 6 depict configurations comprising two or three oxygenators only, it is to be understood that the systems described herein can comprise additional oxygenators, which may be arranged in serial and/or in parallel with the oxygenators depicted in the Figures.

FIG. 5 depicts exemplary configurations comprising at least two oxygenators arranged in series. FIG. 5A depicts a flow-through system comprising a storage tank 50, a pump 52 and two oxygenators 54, 56 in series. In this configuration, one or both of oxygenators 54, 56 may be in communication with a source of oxygenating gas. FIG. 5C depicts a similar configuration that includes a third oxygenator 58. In the configuration shown in FIG. 5C, one or more of oxygenators 54, 56, 58 may be in communication with a source of oxygenating gas.

FIGS. 5B and 5D depict re-circulating systems having two or three oxygenators, respectively, in series. Source water is pumped from the storage tank 50 by pump 52 and passed through oxygenators 54, 56 (FIG. 5B) or oxygenators 54, 56, 58 (FIG. 5D). The oxygenated water may then be re-circulated through one or more of the oxygenators (54 and/or 56 in FIG. 5B; or 54 and/or 56 and/or 58 in FIG. 5D) in order to increase the oxygenation levels. As with FIGS. 5A and 5C, one or more of oxygenators 54, 56, 58 may be in communication with a source of oxygenating gas.

FIG. 6 depicts exemplary configurations comprising at least two oxygenators arranged in parallel. FIG. 6A depicts a flow-through system comprising a storage tank 50, a pump 52 and two oxygenators 54, 56 in parallel. In this configuration, one or both of oxygenators 54, 56 may be in communication with a source of oxygenating gas. FIG. 6C depicts a similar configuration that includes a third oxygenator 58. In the configuration shown in FIG. 6C, one or more of oxygenators 54, 56, 58 may be in communication with a source of oxygenating gas. The systems depicted in FIGS. 6A and 6C may optionally include a mixer downstream of the two oxygenators 54, 56 to provide additional mixing of the oxygenated water exiting from the oxygenators.

FIGS. 6B and 6D depict re-circulating systems having two oxygenators in series. Source water is pumped from the storage tank 50 by pump 52 and passed through oxygenators 54, 56 (FIG. 6B) or oxygenators 54, 56, 58 (FIG. 6D). The oxygenated water may then be re-circulated through one or more of the oxygenators (54 and/or 56 in FIG. 6B; or 54 and/or 56 and/or 58 in FIG. 6D) in order to increase the oxygenation levels. As with FIGS. 6A and 6C, one or more of oxygenators 54, 56, 58 may be in communication with a source of oxygenating gas and the system may optionally include a mixer downstream of the two oxygenators 54, 56 to provide additional mixing of the oxygenated water exiting from the oxygenators.

While FIGS. 6B and 6D show oxygenator 58 downstream of the in-parallel oxygenators 54, 56, it will be appreciated that the system could also be configured such that oxygenator 58 is upstream of oxygenators 54, 56. Similarly, the system could be configured such that oxygenator 58 was in parallel with oxygenators 54, 56.

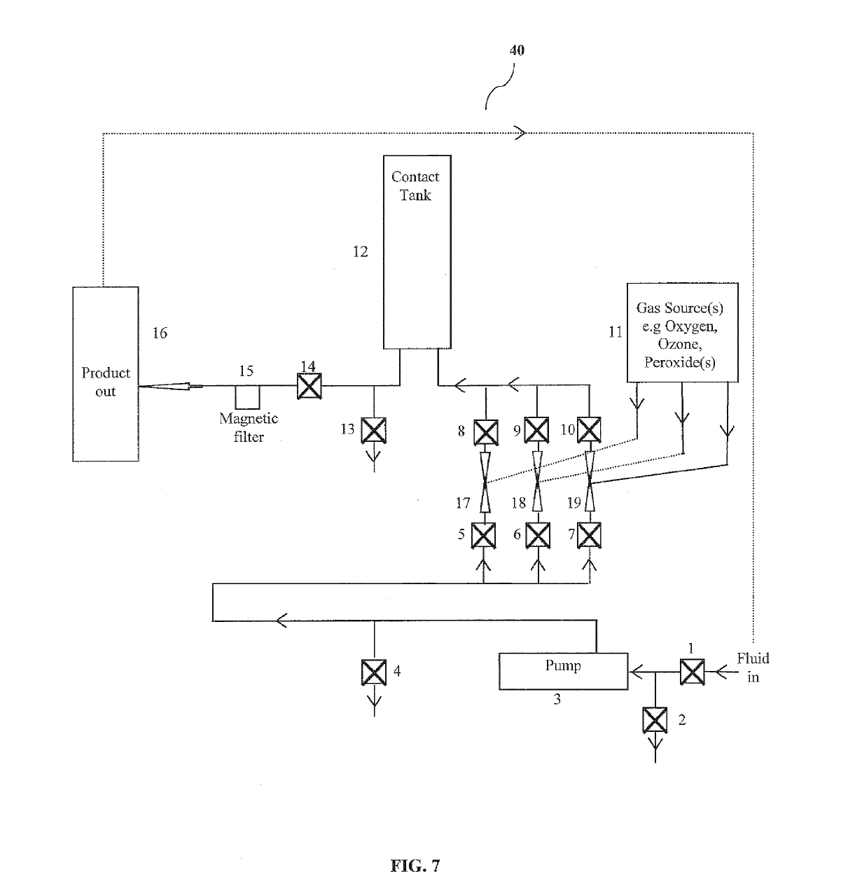

FIGS. 7-9 provide detailed overviews of systems for producing super-oxygenated water in accordance with certain embodiments of the invention. FIG. 7 depicts a system designed to test the efficacy of fluids in parallel and in series with combinations of apparatuses to measure comparable end-points. A source fluid is introduced into the system 40 by opening valve 1 and turning on the pump 3. The fluid may be fluid recirculated from an earlier treatment or fresh fluid introduced from an exogenous source, or a combination thereof. The fluid may be an environmental source, a drinkable fluid, or a recreational industrial, agricultural, medical, or automotive fluid. Appropriate apparatus are selected for the fluid being treated and optimal combinations for a given application may be selected by substituting individual components until the desired end point is achieved. In an exemplary system, the piping may be one inch pvc piping and the valves (1, 2, 4-10, 13, 14), are all selected to be compatible with this dimension, material, and source fluid, although one skilled in the art will appreciate that other sizes and types of piping may be employed taking into account the source fluid and apparatus included in the system.

Individual valves may be left open or closed to isolate individual effects or combinations of effects. Pump 3 may be any pump compatible with the source fluid, pressure limitations, and the other system materials. For example, it may be a centrifugal pump (Gould, 0.75 HP, M/N 4103007456) when using a drinking water as the source fluid. Venturi or other gas injection apparatus (17, 18, 19) are also selected to be compatible with the other system components. A non-limiting example of a suitable Venturi apparatus is any of Mazzei Models 384 through 2081. Other Venturi apparatuses are well-known in the art. Gas for introduction into the system may be provided by tanks or generators, for example, or by other mechanisms known in the art. The gas may be selectively introduced into the system in series or in parallel. In an exemplary system, the gas source is one or more of ozone, oxygen, and peroxides and the source fluid is water or brine. Contact tank 12 may comprise, for example, a diffuser, an LHO or a combination thereof. Other oxygenators may also be employed in this context.

Among many other end points the test bed may be tuned to optimize microbiological quality, viscosity, ionic concentration or other measures. In the exemplary series of experimentation described in the Examples, the end point measured was the level of dissolved oxygen and the stability thereof.

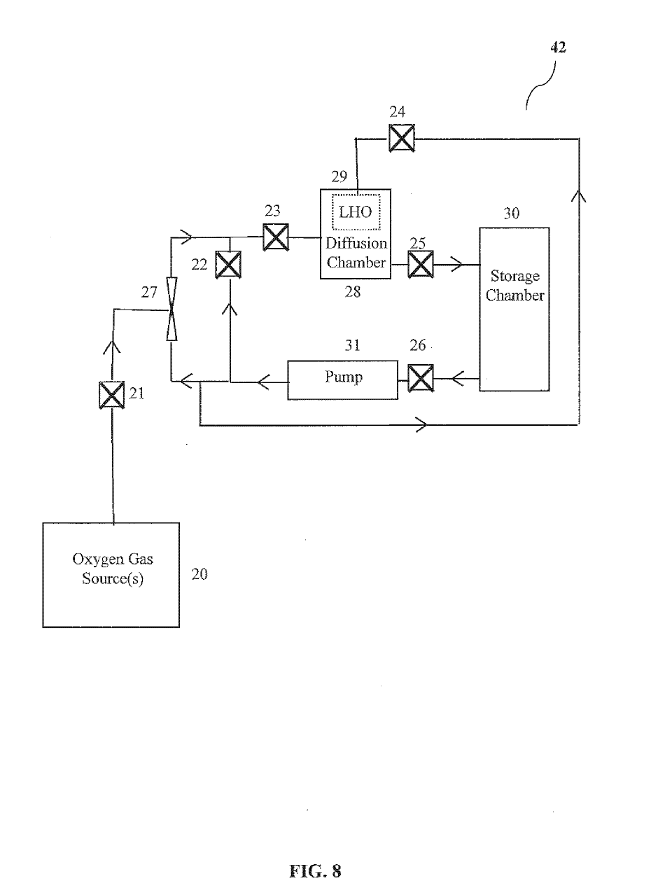

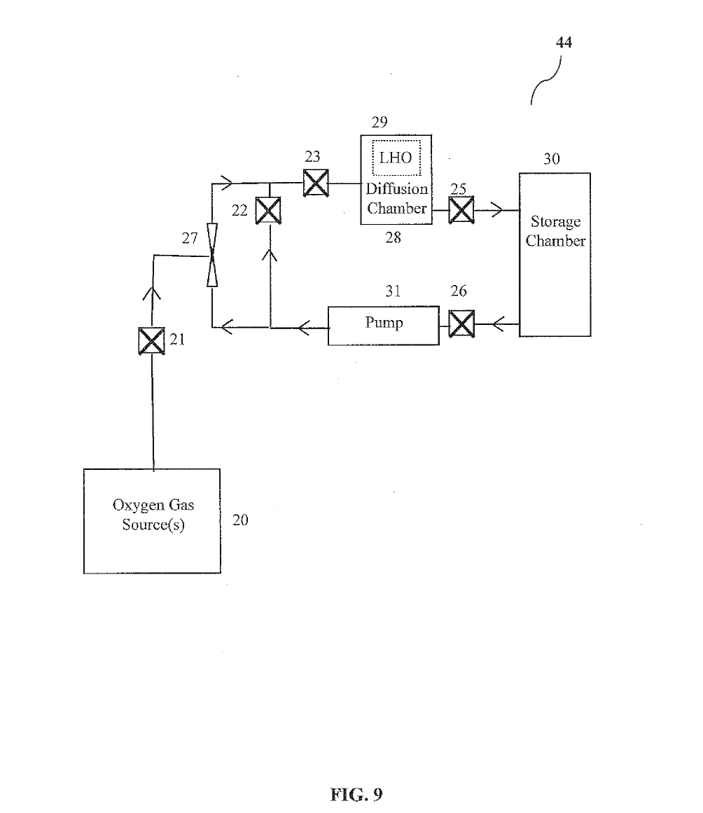

The system 42 shown in FIG. 8 operates by filling the storage tank 30 with the source fluid. When valve 26 is open, source fluid is pumped out of the storage tank 30 by pump 31. The system may be configured to add gas from gas source 20 to the fluid at apparatus 27 by opening valve 21, or apparatus 27 may be fully or partially bypassed by opening valve 22. By shutting valve 23, the system affords the opportunity of passing the fluid through the diffusion chamber 28 or optionally through another mass transfer device 29, which in the embodiment shown in FIG. 8 is a low-head oxygenator (LHO) functioning as an atomizer Closing valve 24 or removing the LHO 29 allows the effects of the diffusion chamber to be determined independently from other apparatus. A cap or valve may also be placed downstream of apparatus 27 to isolate the effects of diffusion chamber 28 on the source fluid. FIG. 9 depicts a system 42, which is the same as the system shown in FIG. 8, but with the line to the LHO 29 removed.

One skilled in the art will appreciate that one or more of the Venturi apparatus, diffusion chamber and LHO shown in FIGS. 8 and 9 may be substituted with other oxygenators and that the system is not limited to the specific combination of apparatus shown.

### Methods

In one aspect, the invention relates to methods of producing super-oxygenated water. In certain embodiments, the method for producing super-oxygenated water comprises passing a source water through a plurality of oxygenators under conditions allowing introduction of oxygen into the source water to provide oxygenated water, the plurality of oxygenators comprising at least two different oxygenators arranged in series or in parallel; passing the oxygenated water through one or more of the plurality of oxygenators one or more times as necessary to provide super-oxygenated water, and collecting the super-oxygenated water.

In certain embodiments, the methods are for producing super-oxygenated water that is essentially free of ions, particulates and solutes. By “essentially free of ions, particulates and solutes” it is meant that the amount of ions, particulates and solutes are below levels detectable by conventional detection methods. Accordingly, in some embodiments, the method further comprises purifying the source water, for example, by removing particulates, dissolved solids and/or ions from the water. In some embodiments, the source water has been previously purified.

In certain embodiments, the methods described herein produce a super-oxygenated water having a minimum dissolved oxygen (DO) content. For example, in some embodiments, the super-oxygenated water produced by the methods described herein has a minimum DO content of 2 times saturation. In certain embodiments, the super-oxygenated water produced by the methods described herein has a minimum DO content of 20 mg/L or greater, for example, 30 mg/L or greater, 40 mg/L or greater or 50 mg/L or greater. In certain embodiments, the super-oxygenated water produced by the methods described herein has a DO content that exceeds 20 mg/L at 1 bar. In some embodiments, the super-oxygenated water produced by the methods described herein has a DO content of 30 mg/L or greater; 40 mg/L or greater, or 50 mg/L or greater at 1 bar.

In certain embodiments, the super-oxygenated water produced by the methods described herein has a minimum DO content of 20 mg/L or greater at 1 bar when the temperature is in the range of 15° C. to 23° C. In some embodiments, the super-oxygenated water produced by the methods described herein has a minimum DO content of 30 mg/L, 40 mg/L, or 50 mg/L at 1 bar when the temperature is in the range of 15° C. to 23° C.

In certain embodiments, the methods described herein produce super-oxygenated water with improved stability. For example, in some embodiments, the super-oxygenated water produced by the methods described herein has a super-oxygenation half-life of at least 12 hours or more in an open tank at ambient temperature and pressure. A half life in this context is defined as the time it takes for supersaturated dissolved oxygen level to fall by half. For example, if a sample that has an initial value of 50 mg/L where saturation is defined at 10 mg/L takes 24 hours to fall to a level of 30 mg/L it can be said to have a half life of 24 hours. In some embodiments, the super-oxygenated water produced by the methods described herein has a super-oxygenation half-life of 18 hours or more in an open tank at ambient temperature and pressure. In some embodiments, the super-oxygenated water produced by the methods described herein has a super-oxygenation half-life of 24 hours or more in an open tank at ambient temperature and pressure.

In certain embodiments, the super-saturated water produced by the methods described herein demonstrates an extended stability when bottled. Extended stability may be defined, for example, relative to water treated with only one oxygenator. For example, in some embodiments, the DO content of the super-oxygenated water produced by the methods described herein remains above saturation at ambient temperature and pressure for 4 months or more when stored in bottles. In some embodiments, the DO content of the super-oxygenated water produced by the methods described herein remains above saturation at ambient temperature and pressure for 5 months or more when stored in bottles. In accordance with certain embodiments, ambient pressure can be defined as a pressure of 1 bar. In certain embodiments, ambient temperature can be defined as a temperature between about 15° C. and about 23° C., for example, between about 15° C. and about 21° C.

Oxygen may be introduced into the source water at one or more of the oxygenators. In certain embodiments, the method comprises introducing oxygen at one oxygenator. In some embodiments, the method comprises injecting oxygen into the source water at one oxygenator. In some embodiments, the method comprises diffusing oxygen into the source water at one oxygenator. In some embodiments, the method comprises injecting oxygen into the source water at one oxygenator and diffusing oxygen into the source water at another oxygenator.

The method may further comprise measuring the DO content of the oxygenated water after one or more steps. In certain embodiments, the method comprises measuring the DO content after an initial passage of the source water through the plurality of oxygenators, then passing the oxygenated water through one or more of the plurality of oxygenators one or more times as necessary to provide super-oxygenated water prior to collecting the super-oxygenated water. In some embodiments, the method comprises comparing the measured DO content of the oxygenated water to a pre-set value corresponding to the minimum DO content, and passing the oxygenated water through one or more of the oxygenators one or more times if the DO content is less than the pre-set value. In some embodiments, these steps are repeated until the DO content reaches the pre-set value.

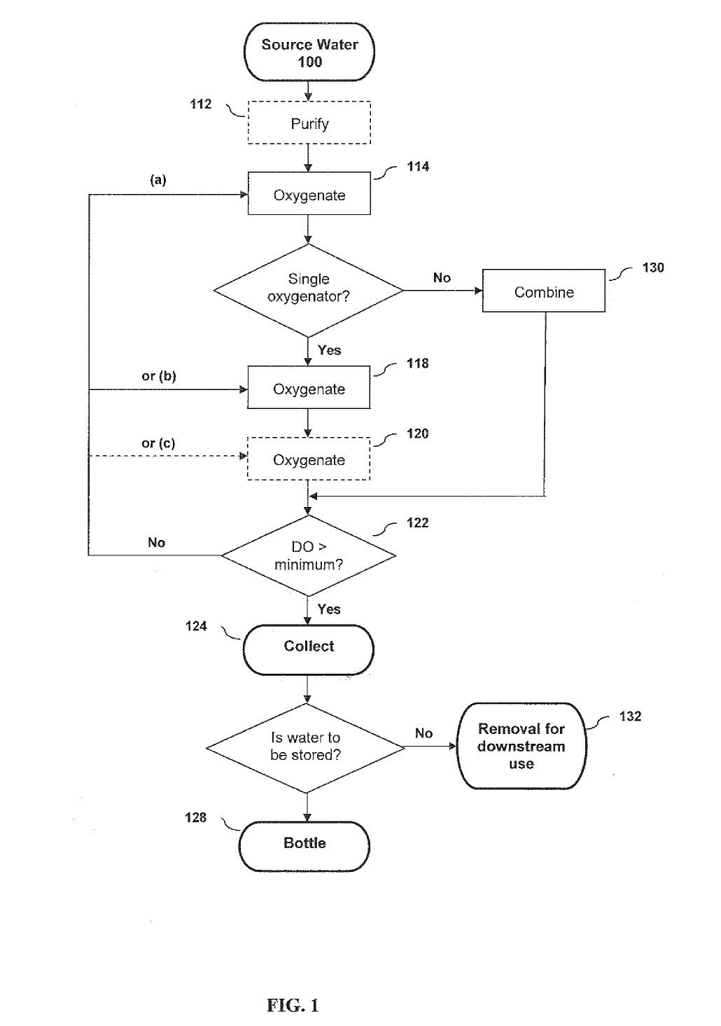

FIGS. 1 to 4 provide non-limiting examples of methods for producing super-oxygenated water in accordance with various embodiments of the invention.

In FIG. 1, source water 100 is optionally purified at step 112 and then oxygenated (step 114). Oxygenation at this step may be achieved by passing the source water through one oxygenator or through a plurality of oxygenators in parallel. If the source water was passed through a single oxygenator, then at step 118, it is submitted to a second oxygenation, for example by passing the water through a second oxygenator, and optionally at step 120, it may be submitted to a third oxygenation, for example, by passing the water through a third oxygenator. The terms “oxygenate” and “oxygenation” in this context mean that oxygen is introduced into the water from an exogenous source, or is introduced by mixing with in-process oxygenated water, or by mixing or otherwise treating the water such that the oxygen content is increased. Alternatively if oxygenation at step 114 comprised passing the source water through a plurality of oxygenators in parallel, then the output from the oxygenators is combined at step 130. Combination may be by simply combining the in-process streams or it may comprise physical mixing of the in-process streams.

At step 122, the DO content of the treated water can be determined and if it is lower than a pre-determined minimum (for example, 20 mg/L, 30 mg/L, 40 mg/L or 50 mg/L) then the treated water can be treated again by submitting it to all oxygenation steps (option (a)), to the second and optional third oxygenation steps (option (b)) or to just the third oxygenation step (option (c)).

Once the treated water reaches the required minimum DO content, the super-oxygenated water is collected at step 124 and either removed for downstream use (step 132) or bottled (step 128).

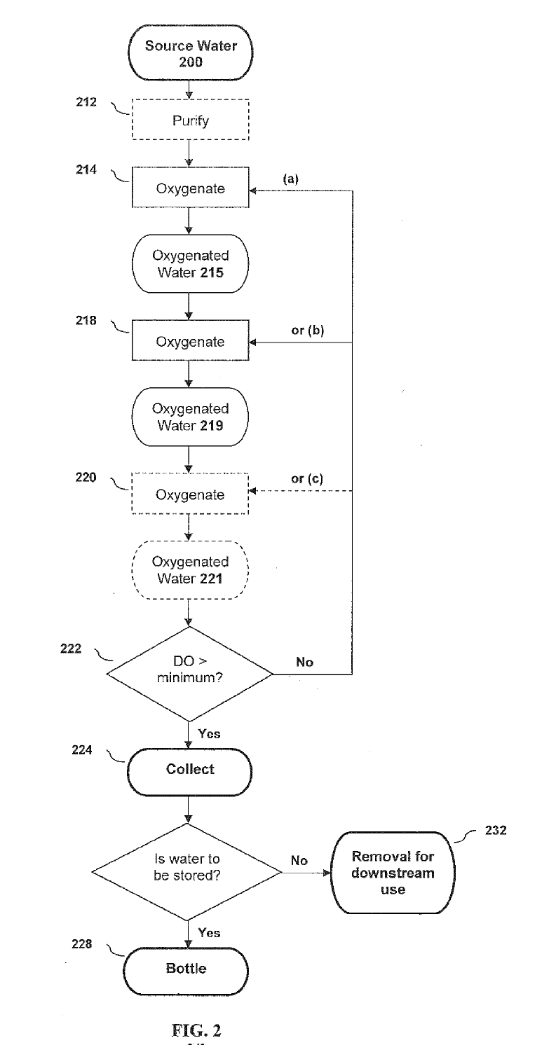

FIG. 2 shows an exemplary method in which the oxygenation steps take place in series. According to this embodiment, source water 200 is optionally purified at step 212 and then oxygenated (step 214) by passing the source water through an oxygenator. The oxygenated water 215 from step 214 is then submitted to a second oxygenation at step 218, for example by passing the water through a second oxygenator. The oxygenated water 219 from step 218 can optionally be submitted to a third oxygenation at step 220, for example, by passing the water through a third oxygenator. At step 222, the DO content of the treated water can be determined and if it is lower than a pre-determined minimum (for example, 20 mg/L, 30 mg/L, 40 mg/L or 50 mg/L) then the treated water can be treated again by submitting it to all oxygenation steps (option (a)), to the second and optional third oxygenation steps (option (b)) or to just the third oxygenation step (option (c)). Once the treated water reaches the required minimum DO content, the super-oxygenated water is collected at step 224 and either removed for downstream use (step 232) or bottled (step 228).

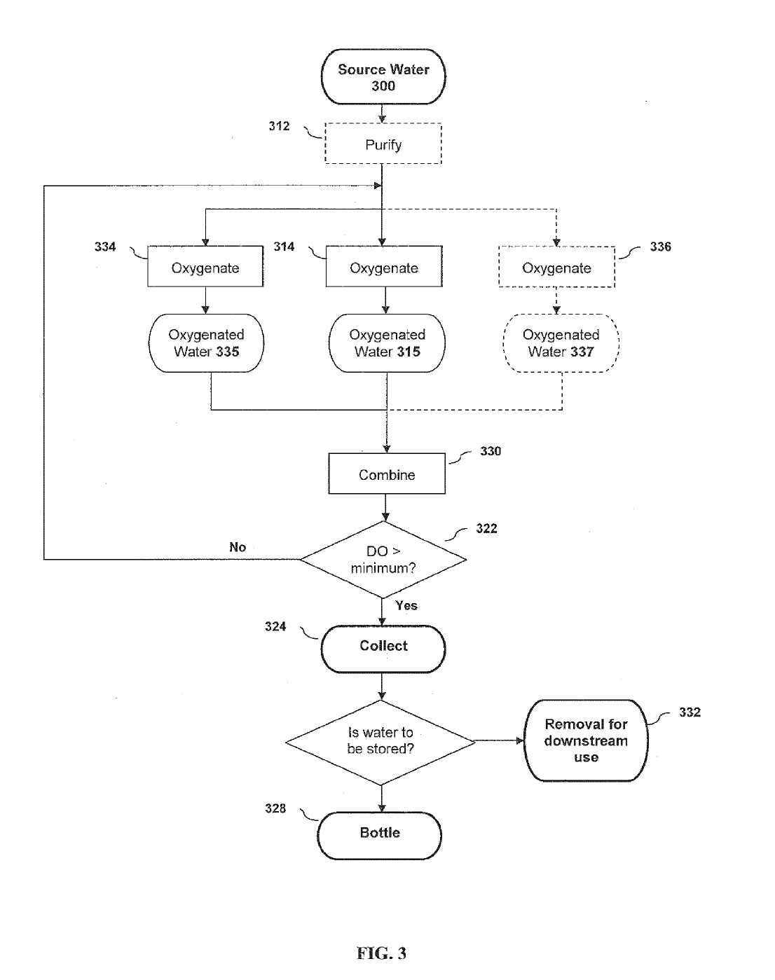

FIG. 3 shows an exemplary method in which the oxygenation steps take place in parallel. According to this embodiment, source water 300 is optionally purified at step 312 and then submitted to two or optionally three oxygenation steps in parallel (steps 314, 334, 336) by passing the source water through in-parallel oxygenators. At step 330, the output from the oxygenators is combined. As for FIG. 1, combination may be by simply combining the in-process streams or it may comprise physical mixing of the in-process streams. At step 322, the DO content of the treated water can be determined and if it is lower than a pre-determined minimum (for example, 20 mg/L, 30 mg/L, 40 mg/L or 50 mg/L) then the treated water can be treated again by submitting it to one or more of the in-parallel oxygenation steps. Once the treated water reaches the required minimum DO content, the super-oxygenated water is collected at step 324 and either removed for downstream use (step 332) or bottled (step 328).

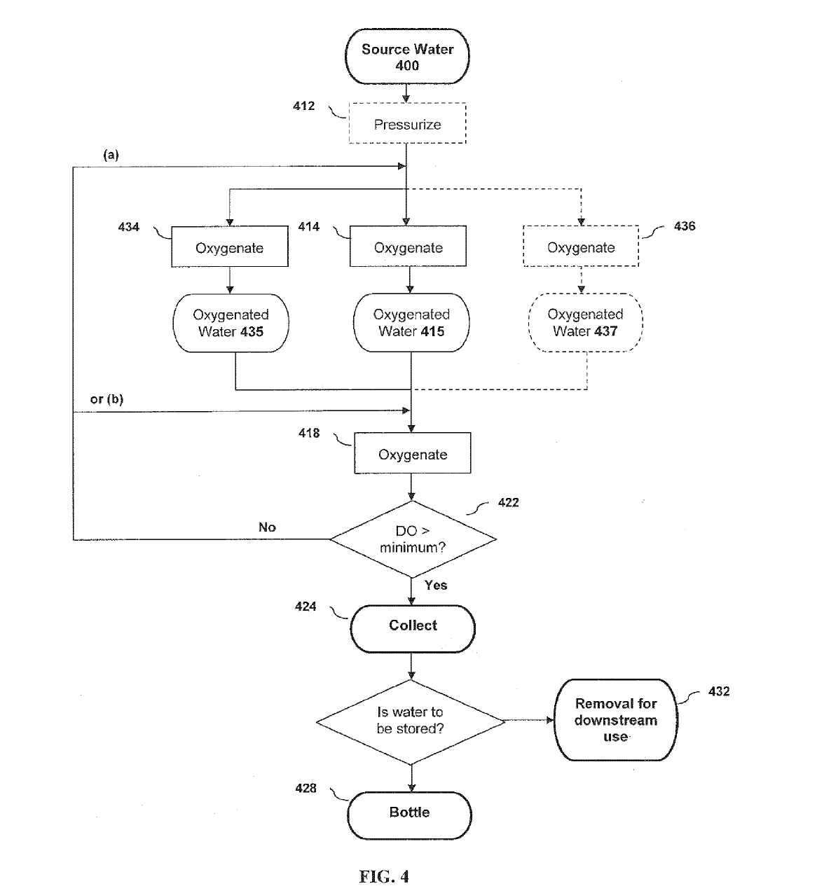

FIG. 4 shows an exemplary method which combines in-series and in-parallel oxygenation steps. According to this embodiment, source water 400 is optionally purified at step 412 and then submitted to two or optionally three oxygenation steps in parallel (steps 414, 434, 436) by passing the source water through in-parallel oxygenators. The output from the oxygenators is combined as in FIG. 3 and submitted to a further oxygenation step 418, for example, by passing the oxygenated water through an in-series oxygenator. At step 422, the DO content of the treated water can be determined and if it is lower than a pre-determined minimum (for example, 20 mg/L, 30 mg/L, 40 mg/L or 50 mg/L) then the treated water can be treated again by submitting it to one or more of the in-parallel oxygenation steps and the in-series oxygenation step (option (a)) or to just oxygenation step 418 (option (b)). Once the treated water reaches the required minimum DO content, the super-oxygenated water is collected at step 424 and either removed for downstream use (step 432) or bottled (step 428).

### APPLICATIONS

The systems and methods described herein have application in a number of industries including, but not limited to, aquaculture, animal husbandry, wastewater industries, agricultural industries, research industries, medical industries, chemical industries and food industries.

In the food industry, for example, drinkable aqueous solutions that may benefit from an oxygenating process step as described herein include without limitation, infusions, alcoholic beverages, marinades, juices, dairy products, frozen drinks, flavoured drinks, carbonated drinks reformulated using oxygen gas instead of CO₂, and the like. Food products that may be improved with oxygenation include foods that have one of the above mentioned aqueous fluids as an ingredient. One skilled in the food sciences will recognize the value of oxygenation in food processing and the many possible uses of highly oxygenated ingredients.

In the chemical industries, it will be appreciated by those skilled in the art that by tuning the oxygen levels in aqueous solutions, it may be possible to modify or improve some reactions.

To gain a better understanding of the invention described herein, the following examples are set forth. It will be understood that these examples are intended to describe illustrative embodiments of the invention and are not intended to limit the scope of the invention in any way.

### EXAMPLES

### Example 1

### Venturi Plus Diffusion Treatment—Reverse Osmosis Treated Water

A number of pumps, Venturi apparatus, and diffusers were employed to superoxygenate various source waters. Venturi apparatus or diffusers individually connected to an oxygenation source and used to treat water will yield only transient supersaturation of the source water. Moreover, the purer the source water, the more transient the effect tends to be. Normally, depending on the model, a half life of less than 6 hours in an unsealed tank is observed. This means that within 24 hours the super-oxygenation is barely discernible.

In this example, 100 L of Municipal water (City of Edmonton, Canada) was collected in a tank, treated by reverse osmosis (RO) and returned to the tank for use in the experiment. To saturate this in-process water with oxygen, it was pumped through a Venturi (Mazzei Model 584) being injected with oxygen supplied from an oxygen generator (Air Sep, M/N TOPAZ plus) using a centrifugal pump (Gould, 0.75 HP, M/N 4103007456). Once collected, this water was repeatedly passed through a diffusion chamber containing a stainless steel diffuser (100 micron mesh) or both the Venturi apparatus and diffusion chamber until the water registered between 20 and 25 mg/L of dissolved oxygen (approximately 5 repeat treatments) as measured by a hand-held dissolved oxygen meter (Hanna, model number HI 9147). This in-process water is identified herein as VdiffRO water. The water showed approximately 175% of expected oxygen saturation for this type of water at ambient temperature and pressure.

In addition, the use of the diffuser/Venturi combination yielded a more stable variant. In the inventors' experience with these combinations, the super-oxygenation half life of the water may be extended to between 12 and 18 hours in an unsealed tank, meaning the combination treatment exceeds the stability of either the diffuser or Venturi apparatus alone.

### Example 2

### Venturi Plus Diffusion Treatment—Distilled Water

In this example, 100 L of Municipal water (City of Edmonton, Canada) was collected in a tank, then distilled and returned to the tank for use in the experiment. To saturate this in-process water with oxygen, it was pumped through a Venturi (Mazzei Model 584) being injected with oxygen supplied from an oxygen generator (Air Sep, M/N TOPAZ plus) using a centrifugal pump (Gould, 0.75 HP, M/N 4103007456). Once collected, this water was repeatedly passed through a diffusion chamber or both the Venturi apparatus and diffusion chamber until the water registered between 20 and 25 mg/L of dissolved oxygen (approximately 5 repeat treatments) as measured by a hand-held dissolved oxygen meter (Hanna, model number HI 9147). This in-process water is identified herein as VdiffD water. The water showed approximately 175% of expected oxygen saturation for this type of water at ambient temperature and pressure.

In addition, the use of the diffuser/Venturi combination yielded a more stable variant. In the inventors' experience with these combinations, the super-oxygenation half life of the water may be extended to 12 to 18 hours in an unsealed tank, meaning the combination treatment exceeds the stability of either the diffuser or Venturi apparatus alone.

### Example 3

### Venturi Plus Diffusion Treatment—Municipal Water

In this example, 100 L of Municipal water (City of Edmonton, Canada) was collected in a tank. To saturate this in-process water with oxygen, it was pumped through a Venturi (Mazzei Model 584) being injected with oxygen supplied from an oxygen generator (Air Sep, M/N TOPAZ plus) using a centrifugal pump (Gould, 0.75 HP, M/N 4103007456). Once collected, this water was repeatedly passed through a diffusion chamber or both the Venturi apparatus and diffusion chamber until the water registered between 41 and 47 mg/L of dissolved oxygen (approximately 5 repeat treatments) as measured by a hand-held dissolved oxygen meter (Hanna, model number HI 9147). This in-process water is identified herein as VdiffTap water. The dissolved oxygen meter calculated approximately 650% of expected oxygen saturation for this type of water at ambient temperature and pressure.

In addition, the use of the diffuser/Venturi combination yielded a more stable variant. In the inventors' experience with these combinations, the super-oxygenation half life of the water may be extended to between 12 and 18 hours in an unsealed tank, meaning the combination treatment exceeds the stability of either the diffuser or Venturi apparatus alone. Retention of ionic materials helps to stabilize oxygenation.

### Example 4

### Further Treatment of VdiffRO and VdiffD Water

A tank with 100 litres of each Vdiff water (either VdiffRO or VdiffD) from Examples 1 or 2 respectively was reprocessed with a control valve placed on the discharge from the diffusion chamber. The reprocessing continued until the dissolved oxygen level reached between 30 and 35 mg/L (4 to 6 repeat treatments). The water showed approximately 340% of expected oxygen saturation for each type of water at ambient temperature and pressure.

The stability of this water was not tested.

### Example 5

### Further Treatment of Vdiff Water with a Mister

100 litres each of VdiffRO and VdiffD made with the method of Example 4 were treated with a Low Head Oxygenator (LHO) as a mister until measurement exceeded the 50 mg/L limit of the meter (for 4 to 6 repeat treatments). The water showed at least 500% of expected oxygen saturation for this type of water at ambient temperature and pressure. VdiffTap was not tested as results would exceed measurement capacity of the instrument.

In addition, the use of the diffuser/Venturi/mister combination yielded an even more stable variant. In the inventors' experience with these combinations, the super-oxygenation half life of the water may be extended to between 36 to 72 hours in an unsealed tank, meaning the combination treatment exceeds the stability of the diffuser/Venturi combination alone.

### Example 6

### Stability of the Treated Water

Waters produced by the method of Example 5 were left in an tank at ambient temperature and pressure for 2 weeks and retained some supersaturation. Preliminary estimates suggest that the half-life of dissolved oxygen in purified waters of Example 4 will be between 5 and 10 days.

### Example 7

### Stability of Purified Super-Oxygenated Water in Bottles

Water that had been treated by reverse osmosis was processed in a test bed configured as shown FIG. 8 with valves 21, 23, 24, 25, and 26 fully open. In this configuration, the water was pumped from the storage chamber 30 through either the Venturi apparatus 27, where oxygen was injected into the water from oxygen gas source 20, and then through the diffusion chamber 28, or through the LHO 29 and then through the diffusion chamber 28. The oxygen source used in this Example was an Air Sep AS 12 oxygen generator. The combined in-process streams were then returned to the storage tank 30 and recirculated as necessary. Water was recirculated until dissolved oxygen in the water in storage chamber 30 exceeded the limitations of hand-held dissolved oxygen meter (Hanna, model number HI 9147). Water from the tank was then bottled by hand in 500 ml polyethylene bottles and 18.9 L polycarbonate bottles. The water was stored at either 21° C. or 4° C. and sampled periodically to assess the dissolved oxygen content using the above-mentioned hand-held dissolved oxygen meter. The results are shown in Table 1.

TABLE 1
Stability of Bottled Reverse Osmosis
Treated Super-Oxygenated Water

| | Dissolved Oxygen (DO) Level (mg/L) | | |
|---|---|---|---|
| | 500 ml bottles | 500 ml bottles | 18.9 L bottles |
| Date Tested | at 21° C. | at 4° C. | at 21° C. |
| Jun. 8, 2012 | 45 | 45 | 45 |
| Jun. 9, 2012 | 40 | 42 | |
| Jun. 16, 2012 | 36 | 38 | |
| Jul. 16, 2012 | 28 | 30 | 28 |
| Aug. 16, 2012 | 24 | 26 | 24 |
| Sep. 20, 2012 | 23 | 26 | 20 |
| Oct. 22, 2012 | 22 | 23 | |
| Nov. 18, 2012 | 20 | 21 | |

The results show that, in either format, the dissolved oxygen level held at above saturation levels for over 4 months.

### Example 8

### Stability of Purified Super-Oxygenated Water in Open Tank

For comparison, the stability of unpackaged reverse osmosis water treated as described in Example 7 was tested in an open tank. The results are shown in Table 2.

TABLE 2
Stability of Unpackaged Reverse Osmosis
Treated Super-Oxygenated Water

| | Dissolved Oxygen (DO) | |
|---|---|---|
| Date Tested | Level at 21° C. (mg/mL) | % Above Saturation |
| May 20, 2012 | 45 | 600 |
| May 21, 2012 | 34 | 550 |
| May 24, 2012 | 28 | 475 |
| May 28, 2012 | 24 | 425 |
| Jun. 7, 2012 | 18 | 325 |

The results show that dissolved oxygen diminished much more rapidly with a super-oxygenation half life of about ten days. In contrast, super-oxygenated water produced by other conventional treatment methods tested has a half-life of under one hour.

### Example 9

### Stability of Purified Super-Oxygenated Water in Bottles

Reverse osmosis water was processed in a test bed configured as shown in FIG. 9 with valves 21, 23, 25 and 26 fully open. In this configuration, the water was pumped from the storage chamber 30 through the Venturi apparatus 27 (Air Sep AS 12 oxygen generator) where oxygen was injected into the water from oxygen gas source 20, through the diffusion chamber 28, then returned to the storage tank 30 and recirculated as necessary. Water was recirculated until dissolved oxygen in the water in storage chamber 30 exceeded the limitations of hand-held dissolved oxygen meter (Hanna, model number HI 9147). Super-oxygenated water was bottled in 500 ml plastic bottles and tested as described in Example 7. The results are shown in Table 3.

TABLE 3
Stability of Bottled Reverse Osmosis
Treated Super-Oxygenated Water

Dissolved Oxygen (DO) Level (mg/L)

| Date Tested | At 21° C. | At 4° C. |
|---|---|---|
| Jun. 24, 2012 | >50 | >50 |
| Jun. 26, 2012 | 44 | N/A |
| Jul. 3, 2012 | 42 | 46 |
| Aug. 2, 2012 | 36 | 38 |
| Sep. 10, 2012 | 26 | 30 |
| Oct. 16, 2012 | 24 | 27 |
| Nov. 12, 2012 | 22 | 24 |
| Dec. 6, 2012 | 21 | 24 |

The results show that the water again exhibited superior retention of dissolved oxygen, with dissolved oxygen levels remaining above saturation for over 5 months.

### Example 10

### Bubble Size

Super-oxygenated water produced in another batch by the method described in Example 7 was passed through a 5 micron precision sizing stainless steel mesh. No change in the level of dissolved oxygen was observed after this treatment. Since bubbles larger than 5 microns would have been excluded by this treatment, thereby lowering the dissolved oxygen level, it can be concluded that oxygen bubbles present in the super-oxygenated water prior to passage through the mesh were smaller than 5 microns. Given some size dispersion likely exists, this indicates the average bubble size in the test fluid was significantly smaller than the 5 micron (5,000 nm) exclusion limit.

### Example 11

### Super-Oxygenation of Brines Using Different Oxygen Sources

This Examples describes the results of several experiments conducted to determine the effect of oxygenation and super-oxygenation on brines. The test solution was obtained from Ward Chemicals and may be described as follows:

| Calcium Chloride | 27% | |
|---|---|---|
| Magnesium Chloride | 4.00% | |
| Sodium Chloride | 2.50% | |
| Potassium Chloride | 1.50% | |
| pH | 5 | |
| Density | 1.32 | Kg/L |
| Iron | 50 | ppm |

All experiments were conducted using a test bed configured as shown in FIG. 7 with fluid circulated for the measured amount of time and the additional end points measured being change in dissolved or suspended solids, change in oxygenation, and the buffering action of individual injectates or combinations thereof. Results are shown in Table 4.

TABLE 4
Oxygenation and Super-oxygenation of Brines

| | | TSS/TDS* | | DO (mg/L) | | pH | |
|---|---|---|---|---|---|---|---|
| Date | Treatment | Before | After | Before | After | Before | After |
| Mar. 11, | 10 minutes; | 210 | 410 | 4.8 | 16.4 | 4.1 | 4.3 |
| 2013 | No gas | | | | | | |
| Mar. 18, | 15 minutes; | 208 | 405 | 4.1 | 15.1 | 4.1 | 4.3 |
| 2013 | No gas | | | | | | |
| Mar. 25, | 10 minutes; | 210 | 360 | 4.1 | 12.5 | 4.1 | 4.2 |
| 2013 | No gas | | | | | | |
| Mar. 11, | Air 15 L/Min | 2890 | 3190 | 3.7 | 4.1 | 3.8 | 6.9 |
| 2013 | for 10 minutes | | | | | | |
| Mar. 18, | Air 10 L/Min | 2890 | 2500 | 3.9 | 4.4 | 4.1 | 5.5 |
| 2013 | for 10 minutes | | | | | | |
| Mar. 25, | Air 3 L/Min | 2890 | 2590 | 3.9 | 4.0 | 4.2 | 7.0 |
| 2013 | for 15 minutes | | | | | | |
| Mar. 11, | O₂ 2 L/Min for | 2890 | 2230 | 3.9 | 12.4 | 4.1 | 7.1 |
| 2013 | 15 minutes | | | | | | |
| Mar. 18, | O₂ 2 L/Min for | 2890 | 2230 | 4.1 | 10.9 | 3.9 | 6.9 |
| 2013 | 15 minutes | | | | | | |
| Mar. 25, | O₂ 5 L/Min for | 2890 | 2325 | 3.9 | 12.8 | 3.9 | 7.0 |
| 2013 | 15 minutes | | | | | | |
| Mar. 11, | O₃ 1.5 L/Min | 2890 | 2160 | 4.1 | 13.7 | 3.9 | 7.0 |
| 2013 | @6% B.W.^{§} | | | | | | |
| | for 15 minutes | | | | | | |
| Mar. 18, | O₃ 2 L/Min | 2890 | 2160 | 4.1 | 13.7 | 3.9 | 7.2 |
| 2013 | @6% B.W. | | | | | | |
| | for 15 minutes | | | | | | |
| Mar. 25, | O₃ 1.5 L/Min | 2890 | 2250 | 4.1 | 14.8 | 3.9 | 7.4 |
| 2013 | @6% B.W. for | | | | | | |
| | 15 minutes | | | | | | |
| Mar. 11, | H₂O₂ @ 10%/ | 2890 | 9580 | 4.2 | 28.6 | 4.1 | 6.2 |
| 2013 | Air @ 3 L/Min | | | | | | |
| | for 15 minutes | | | | | | |
| Mar. 18, | H₂O₂ @ 10%/ | 2890 | 9742 | 4.1 | 32.1 | 4.2 | 6.1 |
| 2013 | Air @ 4 L/Min | | | | | | |
| | for 15 minutes | | | | | | |
| Mar. 25, | H₂O₂ @ 10%/ | 2890 | 10000 | 4.2 | 36.8 | 4.1 | 7.0 |
| 2013 | Air @ 5 L/Min | | | | | | |
| | for 15 minutes | | | | | | |
| Mar. 11, | H₂O₂ @ 10%/ | 2890 | 4520 | 4.1 | 39.8 | 4.2 | 7.1 |
| 2013 | O₃ 1.5 L/Min | | | | | | |
| | @6% B.W. for | | | | | | |
| | 15 minutes | | | | | | |
| Mar. 18, | H₂O₂ @ 10%/ | 2890 | 6260 | 4.2 | 42.2 | 4.1 | 7.2 |
| 2013 | O₃ 3 L/Min | | | | | | |
| | @6% B.W. for | | | | | | |
| | 15 minutes | | | | | | |
| Mar. 25, | H₂O₂ @ 10%/ | 2890 | 7210 | 4.2 | 45.4 | 4.1 | 7.4 |
| 2013 | O₃ 5 L/Min | | | | | | |
| | @6% B.W. for | | | | | | |
| | 15 minutes | | | | | | |
| Mar. 11, | H₂O₂ @ 10%/ | 2890 | 7980 | 4.2 | 29.2 | 4.1 | 6.9 |
| 2013 | O₂ 1.5 L/Min | | | | | | |
| | for 15 minutes | | | | | | |
| Mar. 18, | H₂O₂ @ 10%/ | 2890 | 9760 | 4.2 | 43.7 | 4.1 | 7 |
| 2013 | O₂ 3 L/Min for | | | | | | |
| | 15 minutes | | | | | | |
| Mar. 25, | H₂O₂ @ 10%/ | 2890 | 10000 | 4.2 | 46.7 | 4.1 | 7.3 |
| 2013 | O₂ 5 L/Min for | | | | | | |
| | 15 minutes | | | | | | |

*TDS = Total Dissolved Solids; TSS = Total Suspended Solids
^{§}B.W. = By Weight.

The results indicate that the systems and methods described herein can be used in highly ionic environments. Brines are typically more refractive to oxygenation than less ionic waters. The results also show that oxygenation can be achieved using a variety of oxygen-bearing species as the oxygen source in the methods and systems described herein.

Test beds as shown in FIGS. 7, 8 and 9 afford the opportunity of creating many new fluid:gas compositions with new properties. As shown in Examples 9-11, numerous solutions containing high amounts of dissolved oxygen were made using such test beds.

The disclosures of all patents, patent applications, publications and database entries referenced in this specification are hereby specifically incorporated by reference in their entirety to the same extent as if each such individual patent, patent application, publication and database entry were specifically and individually indicated to be incorporated by reference.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

The embodiments of the invention in which an exclusive property or privilege is claimed are defined as follows:

1. A method for producing super-oxygenated water having a minimum dissolved oxygen (DO) content, the process comprising:
(a) passing a source water through a plurality of oxygenators under conditions allowing introduction of oxygen into the source water to provide oxygenated water, the plurality of oxygenators comprising at least two different oxygenators arranged in series or in parallel;
(b) passing the oxygenated water through one or more of the plurality of oxygenators one or more times as necessary to provide super-oxygenated water having the minimum DO content, and
(c) collecting the super-oxygenated water,
wherein the minimum DO content is at least 20 mg/L and the super-oxygenated water has a super-oxygenation half-life of 12 hours or more in an open tank at ambient temperature and pressure.

2. The method according to claim 1, wherein the source water is municipal water, drinkable aqueous solutions, sea water, fresh water, aquaculture water, irrigation water, industrial water or wastewater.

3. The method according to claim 1 or 2, further comprising removing particulates, dissolved solids, ions, or a combination thereof from the source water prior to step (a).

4. A method for producing super-oxygenated water essentially free of ions, particulates and solutes and having a minimum dissolved oxygen (DO) content, the process comprising:
(a) passing a source water that has been treated to remove ions and solutes through a plurality of oxygenators under conditions allowing introduction of oxygen into the source water to provide oxygenated water, the plurality of oxygenators comprising at least two different oxygenators arranged in series or in parallel;
(b) passing the oxygenated water through one or more of the plurality of oxygenators one or more times as necessary to provide super-oxygenated water having the minimum DO content, and
(c) collecting the super-oxygenated water,
wherein the minimum DO content is at least 20 mg/L and the super-oxygenated water has a super-oxygenation half-life of 12 hours or more in an open tank at ambient temperature and pressure.

5. The method according to any one of claims 1 to 4, wherein the at least two oxygenators have different bubble size distribution signatures.

6. The method according to any one of claims 1 to 5, wherein the plurality of oxygenators comprise a Venturi apparatus, a diffuser and a low head oxygenator.

7. The method according to claim 6, wherein oxygen-containing gas is injected into the Venturi apparatus.

8. The method according to any one of claims 1 to 5, wherein the at least two different oxygenators are arranged in parallel.

9. The method according to claim 8, wherein step (a) comprises passing the source water through a first oxygenator under conditions allowing introduction of oxygen into the source water to provide oxygenated water and through a second oxygenator in parallel with the first oxygenator.

10. The method according to any one of claims 1 to 5, wherein the at least two different oxygenators are arranged in series.

11. The method according to claim 10, wherein step (a) comprises passing the source water through a first oxygenator under conditions allowing introduction of oxygen into the source water to provide oxygenated water, and passing the oxygenated water through a second oxygenator in series with the first oxygenator.

12. The method according to claim 9 or 11, wherein step (b) further comprises measuring the DO content of the oxygenated water, comparing the DO content of the oxygenated water to a pre-set value corresponding to the minimum DO content, and passing the oxygenated water through the first oxygenator, the second oxygenator or both the first and second oxygenators one or more times if the DO content is less than the pre-set value.

13. The method according to any one of claim 9, 11 or 12, wherein step (a) further comprises passing the oxygenated gas through a third oxygenator.

14. The method according to claim 13, wherein the first, second and third oxygenators are different types of oxygenators.

15. The method according to claim 14, wherein the first, second and third oxygenators have different bubble size distribution signatures.

16. The method according to any one of claims 9 and 11 to 15, wherein passing the source gas through the first oxygenator comprises subjecting the source water to shear stress in the presence of an oxygenating gas.

17. The method according to claim 16, wherein the first oxygenator comprises a Venturi apparatus.

18. The method according to claim 17, further comprising subjecting the water passing through the Venturi apparatus to a short-wave electromagnetic field.

19. The method according to any one of claims 9 and 11 to 18, wherein passing the oxygenated water through the second oxygenator comprises diffusing the oxygenated water into in-process water.

20. The method according to claim 19, wherein the second oxygenator comprises a diffuser.

21. The method according to any one of claims 9 and 11 to 20, wherein the third oxygenator comprises a low head oxygenator.

21. The method according to any one of claims 9 and 11 to 18, wherein the second oxygenator comprises a low head oxygenator.

23. The method according to any one of claims 9, 11 to 18 and 21, wherein the third oxygenator comprises a diffuser.

24. The method according to any one of claims 1 to 23, wherein the minimum DO content is 30 mg/L.

25. The method according to any one of claims 1 to 23, wherein the minimum DO content is 40 mg/L.

26. The method according to any one of claims 1 to 23, wherein the minimum DO content is 50 mg/L.

27. The method according to any one of claims 1 to 26, wherein oxygen is introduced in a first oxygenator by contacting the water with an oxygenating gas.

28. The method according to claim 27, wherein the source of the oxygenating gas is air, oxygen, ozone, hydrogen peroxide, or a combination thereof.

29. The method according to any one of claims 1 to 28, further comprising pressurizing the source water prior to step (a).

30. The method according to any one of claims 1 to 29, further comprising passing the super-oxygenated water through a static mixer prior to step (c).

31. The method according to any one of claims 1 to 30, wherein the average oxygen bubble diameter in the super-oxygenated water is less than 5 microns.

32. The method according to any one of claims 1 to 31, further comprising bottling the super-oxygenated water.

33. The method according to claim 32, wherein the DO content of the bottled super-oxygenated water remains above saturation at ambient temperature and pressure for 4 months or more.

34. The method according to any one of claims 1 to 31, further comprising storing the super-oxygenated water.

35. The method according to any one of claims 1 to 34, wherein the source water is at ambient temperature.

36. A super-oxygenated water having a minimum dissolved oxygen (DO) content of 20 mg/L produced by the method according to any one of claims 1 to 35, wherein the super-oxygenated water has a super-oxygenation half-life of 12 hours or more in an open tank at ambient temperature and pressure.

37. A system configured to carry out the method according to any one of claims 1 to 35, the system comprising a plurality of oxygenators, the plurality of oxygenators comprising:
a first oxygenator adapted to receive a source water;
a second oxygenator arranged in parallel with the first oxygenator and adapted to receive the source water, or a second oxygenator arranged in series with the first oxygenator and adapted to receive in-process water from the first oxygenator;
an oxygen source in communication with at least one of the first and second oxygenators and adapted to provide oxygenating gas thereto, and
a pump configured to pump water through the system.

38. The system according to claim 37, further comprising a purifying device upstream of the first oxygenator for removing particulates, dissolved solids, ions, or a combination thereof from the source water.

39. The system according to claim 37 or 38, further comprising a third oxygenator adapted to receive in-process water from the first oxygenator and/or the second oxygenator.

40. The system according to claim 37 or 38, wherein the first and second oxygenators are arranged in parallel and the system further comprises a third oxygenator arranged in parallel with the first and second oxygenators and adapted to receive the source water.

41. The system according to claim 39 or 40, wherein the first, second and third oxygenators have different bubble size distribution signatures.

42. The system according to any one of claims 37 to 41, wherein at least one oxygenator is a Venturi apparatus.

43. The system according to claim 42, wherein the oxygen source is in communication with the Venturi apparatus.

44. The system according to claim 43, wherein the oxygen source is configured to inject the oxygenating gas into the in-process water passing through Venturi apparatus.

45. The system according to any one of claims 37 to 44, wherein at least one of the oxygenators is a diffuser.

46. The system according to any one of claims 37 to 45, wherein at least one of the oxygenators is an LHO.

47. The system according to claim 39, wherein the first oxygenator is a Venturi apparatus, the second oxygenator is an LHO and the third oxygenator is a diffuser.

48. The system according to claim 47, wherein the oxygen source is configured to inject the oxygenating gas into the in-process water passing through Venturi apparatus.

49. The system according to any one of claims 37 to 48, further comprising a static mixer downstream of the plurality of oxygenators.

50. The system according to any one of claims 37 to 49, further comprising a storage tank for receiving source water and/or in-process water.
